(19) United States
(12) Patent Application Publication
(10) Pub. No.: US 2016/0380762 A1
(43) Pub. Date: Dec. 29, 2016

(54) DEVICE, SYSTEM, AND METHOD FOR PROVIDING DATA SECURITY, AND PROGRAM FOR ALLOWING COMPUTER TO EXECUTE THE METHOD

(71) Applicant: Renesas Electronics Corporation, Tokyo (JP)

(72) Inventors: Kenji HIRAO, Tokyo (JP); Satoshi Kawakami, Tokyo (JP)

(21) Appl. No.: 15/098,168

(22) Filed: Apr. 13, 2016

(30) Foreign Application Priority Data
Jun. 26, 2015 (JP) 2015-128808

(51) Int. Cl. H04L 9/06; H04L 9/32; H04L 29/06

(52) U.S. Cl. CPC H04L 9/0618; H04L 63/061; H04L 9/3247; H04L 63/045

(57) ABSTRACT

The present invention provides data security by which a management burden on a client can be lessened.

The steps executed by a server includes Step (520) of receiving plaintext ROM data encrypted with a business operator public key, Step (530) of decrypting the plaintext ROM data encrypted with the business operator public key, Step (535) of generating ciphertext ROM data, Step (540) of encrypting the ciphertext ROM data to generate the ciphertext ROM data encrypted with a client public key, Step (545) of transmitting the ciphertext ROM data to a client as an attached file of a mail, Step (550) of generating the ciphertext ROM data, and Step (565) of executing an application by combining a ROM with a microcontroller chip.

### CROSS-REFERENCE TO RELATED APPLICATIONS

The disclosure of Japanese Patent Application No. 2015-128808 filed on Jun. 26, 2015 including the specification, drawings and abstract is incorporated herein by reference in its entirety.

### BACKGROUND

The disclosure relates to data protection, and more specifically to a technique for providing data security.

For example, Japanese Unexamined Patent Application Publication No. 2011-205646 relating to data protection discloses a technique of “protecting the security and copyright of electronic books and safely distributing to a subscriber and a memory device of a system” (see [Abstract]).

### SUMMARY

For example, in a traditional ROM (Read Only Memory) encryption system for a game machine, a key for encryption and a program for encryption are provided to a client in some cases. In this case, the most important technical information in an encryption process is left to the management system of a client. Therefore, in the case where a loss, leakage, or falsification of the encryption key and the encryption program occurs by negligence or intention of the client, there is a concern about a failure of the system. Therefore, a technique for protecting data independently from the management system of the client is necessary.

The disclosure has been made to solve the above-described problems, and an object thereof in a situation is to provide a technique of protecting data independently from the management system of a client.

According to an embodiment, provided is a device for providing data security. The device includes a memory and a processor that is configured to execute a command while being coupled to the memory. The processor is configured to execute the steps of: obtaining plaintext data that is transmitted from a client device and is encrypted with a public key; obtaining the plaintext data by decrypting the encrypted plaintext data using a private key; generating ciphertext data from the plaintext data using a preliminarily-prepared encryption tool; encrypting the ciphertext data using a public key unique to a client; transmitting the ciphertext data generated by the encryption to the client device; and supplying a control module having the public key written to the client.

In a situation, the management and operation of the key of the “encryption tool” and a program itself are performed by a service provider. Therefore, a risk of loss, leakage, or falsification of the key of the “encryption tool” and the program itself for which the security is required can be considerably reduced.

The above and other objects, characteristics, situations, and advantages of the invention will become apparent from the following detailed description that relates to the invention to be understood in association with the accompanying drawings.

### BRIEF DESCRIPTION OF THE DRAWINGS

FIG. 1 is a diagram for showing an outline of a system according to a situation;

FIG. 2 is a diagram for showing an outline of a system in which secure services are provided to a plurality of clients;

FIG. 3 is a block diagram for showing a hardware configuration of a computer 300;

FIG. 4 is a diagram for showing an outline of a configuration of a system 400;

FIG. 5 is a flowchart for showing a part of a process performed between a service provider and a client;

FIG. 6 is a diagram for showing a configuration in the case where services are provided to a plurality of clients;

FIG. 7 is a block diagram for showing a configuration of a system 700 according to a second embodiment;

FIG. 8 is a diagram for showing an outline of a configuration of a system 800 according to a different situation;

FIG. 9 is a diagram for showing a configuration of a system 900 according to a fourth embodiment;

FIG. 10 is a diagram for showing an outline of a configuration of a system according to a fifth embodiment; and

FIGS. 11A-C are diagrams each showing an example of a screen displayed on a monitor 8 of a computer realizing a server 40.

### DETAILED DESCRIPTION

Hereinafter, embodiments of the present invention will be described with reference to the drawings. In the following description, the same reference numerals are given to the same parts. These names and functions are also the same. Thus, the detailed explanations thereof will not be repeated.

### [Technical Concept]

First, the technical concept according to the disclosure will be described.

(1) Encryption keys and encryption programs are managed and operated not in an area managed by a client, but in an area managed by a service provider.

(2) Regarding transfer of data (for example, game software and other content) between a client and a service provider, when the client transmits the content data to the service provider, the data communications are protected by encryption using encryption software compliant with a public key encryption method and by encryption using SSL/TLS (Secure Socket Layer/Transport Layer Security) communications. On the other hand, when the service provider transmits the data to the client, the data is protected by encryption using encryption software compliant with a public key encryption method and by encryption using a common key.

(3) A key used in an “encryption tool” for encryption is prepared for each client by the service provider. In this case, a key prepared for a client is not provided to the other clients. Further, the number of keys prepared for a client may be two or more. A plurality of keys may be prepared for each client. In this case, each of the keys is different from those prepared for the other clients. The timing when one of the keys to be used is changed may differ on a client basis.

(4) The series of processes is combined with a database, and is automated. The client designates content (for example, game software) to be encrypted on a web browser of a computer used by the client. The series of processes is automatically executed from start to finish by a computer operated by the service provider.

### [Case 1]

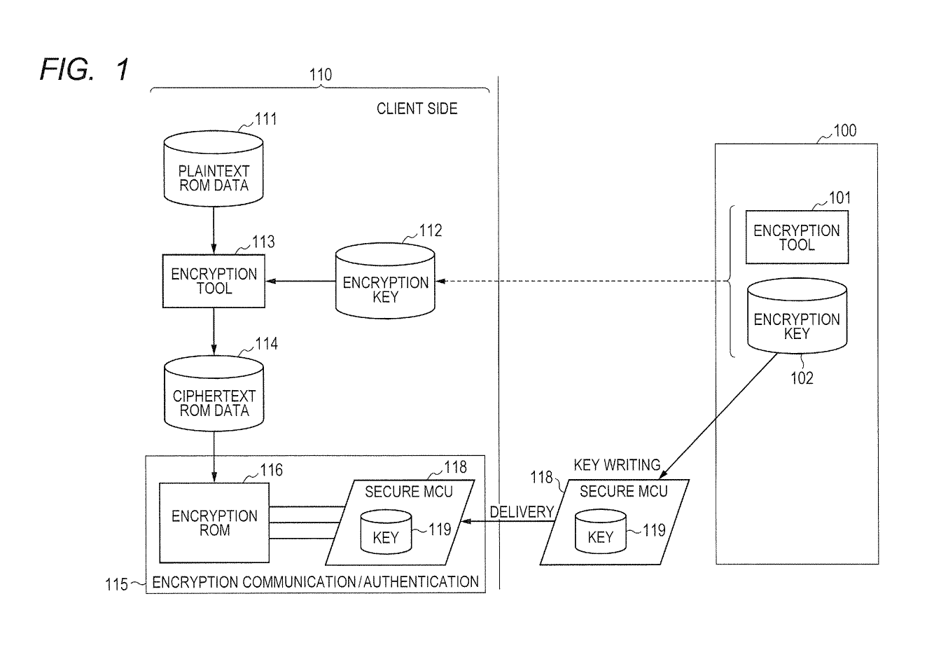

A system according to a situation will be described with reference to FIG. 1. FIG. 1 is a diagram for showing an outline of a system according to a situation. The system includes a server 100 and a server 110.

### (Service Provider)

The server 100 is operated by a service provider that provides secure data. For example, the server 100 provides a client with content protection services. The server 100 manages an encryption tool 101, an encryption key 102, and a secure MCU (Micro Controller Unit) 118. The server 100 provides the client with the encryption key 102. The server 100 is realized by a computer having a well-known configuration. The encryption tool 101 encrypts designated data using the encryption key 102. The type of encryption tool 101 is not particularly limited. The encryption key 102 is prepared in advance by an operator of the server 100.

The server 100 writes the key into the secure MCU 118. The secure MCU 118 is a microcontroller whose system is designed and whose information is managed so that data and programs are protected from unauthorized use or falsification by a third party or a malfunction due to force majeure. For example, the secure MCU 118 includes an encryption key 119. The secure MCU 118 with the encryption key 119 written is delivered to the client.

### (Client Side)

The server 110 includes plaintext ROM data 111, an encryption key 112, an encryption tool 113, ciphertext ROM data 114, and an encryption communication/authentication module 115. The server 110 is realized by, for example, a computer system having a well-known configuration. The encryption communication/authentication module 115 includes an encryption ROM 116 and the secure MCU 118. The secure MCU 118 is supplied from the service provider.

The plaintext ROM data 111 is created by the client. The plaintext ROM data 111 can include, for example, game programs, control programs for devices, and the like.

The encryption key 112 is provided by the server 100. The encryption key 112 can be provided, for example, by sending a data recording medium storing a program and an encryption key for realizing an encryption process or though transmission using a leased line.

The encryption tool 113 encrypts the plaintext ROM data 111 using the encryption key 112 to generate the ciphertext ROM data 114. The type of encryption tool 113 is not particularly limited. The encryption ROM 116 is generated on the basis of the ciphertext ROM data 114.

In the system shown in FIG. 1, the encryption key and the encryption tool are provided from the service provider to the client to entrust the client with the operation. In this case, the number of management steps on the client side is increased. Therefore, an unnecessary burden is put on the primary job. In the case where the management by the client is insufficient, there is a possibility that the encryption key and the encryption tool are leaked to the outside. Thus, the security of the data and programs cannot be secured in some cases.

### [Case 2]

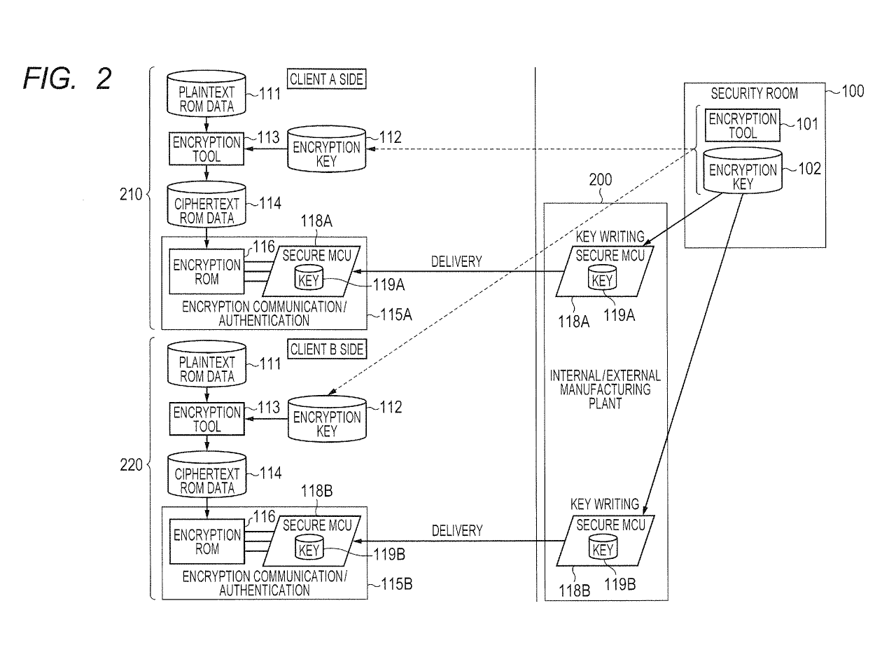

A system according to a different situation will be described with reference to FIG. 2. FIG. 2 is a diagram for showing an outline of a system that provides a plurality of clients with secure services.

A service provider manages a server 100 and a manufacturing plant 200. The manufacturing plant 200 includes a secure MCU 118A and a secure MCU 118B. An encryption key 119A is written into the secure MCU 118A. An encryption key 119B is written into the secure MCU 118B. The manufacturing plant 200 may be managed by the service provider, and the location thereof is not particularly limited. The manufacturing plant 200 includes, at least, a computer system, and may write an encryption key 102 into the secure MCUs 118A and 118B as the encryption keys 119A and 119B in accordance with clients.

A first client A among the clients uses a system 210. The system 210 includes plaintext ROM data 111, an encryption key 112, an encryption tool 113, ciphertext ROM data 114, and an encryption communication/authentication module 115. The encryption communication/authentication module 115A includes an encryption ROM 116 and the secure MCU 118A. The secure MCU 118A is supplied from the service provider.

A second client B uses a system 220. The system 220 includes plaintext ROM data 111, an encryption key 112, an encryption tool 113, ciphertext ROM data 114, and an encryption communication/authentication module 115B. The encryption communication/authentication module 115B includes an encryption ROM 116 and the secure MCU 118B. The secure MCU 118A is supplied from the service provider.

In the system shown in FIG. 2, the encryption key and the encryption tool are provided from the service provider to the client to entrust the client with the operation as similar to the system shown in FIG. 1. In this case, the number of management steps on the client side is increased. Therefore, an unnecessary burden is put on the primary job. In the case where the management by the client is insufficient, there is a possibility that the encryption key and the encryption tool are leaked to the outside. Thus, the security of the data and programs cannot be secured in some cases.

### [Hardware Configuration]

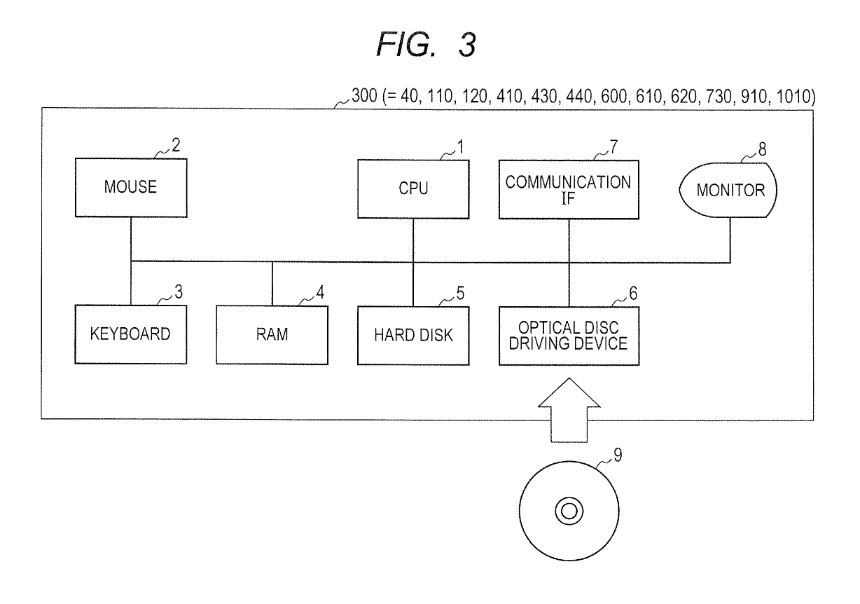

A configuration of a computer 300 according to the disclosure will be described with reference to FIG. 3. FIG. 3 is a block diagram for showing a hardware configuration of the computer 300.

The computer 300 includes, as principal constitutional elements, a CPU (Central Processing Unit) 1 that executes a program, a mouse 2 and a keyboard 3 that accept an instruction input by a user of the computer 300, a volatile RAM (Random Access Memory) 4 that stores data generated by the CPU 1 executing the program or data input through the mouse 2 or the keyboard 3, a non-volatile hard disk 5 that stores data, an optical disc driving device 6, a communication I/F (Interface) 7, and a monitor. The respective constitutional elements are mutually coupled to each other through a bus. A CD-ROM 9 and other optical discs are loaded into the optical disc driving device 6. The communication interface 7 may be a USB (Universal Serial Bus) interface, a wired LAN (Local Area Network), a wireless LAN, a Bluetooth (Registered Trademark) interface, or the like, but is not limited to these interfaces.

A process in the computer 300 is realized by hardware configuring the computer 300 and software executed by the CPU 1. Such software is preliminarily stored in the hard disk 5 in some cases. Further, the software is stored in the CD-ROM 9 or other computer-readable non-volatile data recording media to be distributed as a program product in some cases. Alternatively, the software is provided as a downloadable program product by an information provider coupled to the Internet or other networks in some cases. Such software is read from the data recording medium by the optical disc driving device 6 or other data reading devices, or is downloaded through the communication I/F 7, and then is once stored into the hard disk 5. The software is read from the hard disk 5 by the CPU 1, and is stored into a RAM 4 in a program executable format. The CPU 1 executes the program.

The respective constitutional elements configuring the computer 300 shown in FIG. 3 are general elements. Therefore, essential parts realizing the technical concept in the servers 120 and 130 according to the embodiment can be regarded as programs stored in the computer 300. The operation of the hardware of the computer 300 is well known, and thus the detailed explanation thereof will not be repeated.

It should be noted that the data recording medium is not to limited a CD-ROM, an FD (Flexible Disk), or a hard disk, but may be a non-volatile data recording medium fixedly supporting a program as a semiconductor memory, such as a magnetic tape, a cassette tape, an optical disc (MO (Magnetic Optical Disc)/MD (Mini Disc)/DVD (Digital Versatile Disc)), an IC (Integrated Circuit) card (including a memory card), an optical card, a mask ROM, an EPROM (Electronically Programmable Read-Only Memory), an EEPROM (Electronically Erasable Programmable Read-Only Memory), or a flash ROM. The program in this case can include not only a program that can be directly executed by a CPU, but also a program in a source program format, a compressed program, or an encrypted program.

The servers or the systems used by the client and the service provider according to the disclosure can be realized by the computer 300 as shown in FIG. 3. It should be noted that a part or all of functions realized by the servers or the systems may be realized by circuit elements or other hardware in a different situation.

### First Embodiment

Next, a first embodiment for realizing the disclosed technical concept will be described.

(1) A client prepares a personal computer (hereinafter, also referred to as a PC) that can be coupled to the Internet. Web browser software, mail software, public key encryption software, and a public key and a private key generated by the software are installed in the PC.

(2) A service provider prepares an external public webserver for receiving content sent from the client in the SSL/TLS communication environment, and a ROM encryption server coupled to the external public webserver through a network. A firewall is provided in the network if necessary. It should be noted that a network system on the service provider side is not particularly limited.

(3) The external public webserver can be communicated with the client through the Internet, and further is coupled to the ROM encryption server through an intranet of the service provider.

(4) In the ROM encryption server, mounted is an environment in which data transfer from the external public webserver, an encryption process and a decryption process by the public key encryption software, an encryption process by an encryption tool, client key management, mail address management, and mail transmission can be executed.

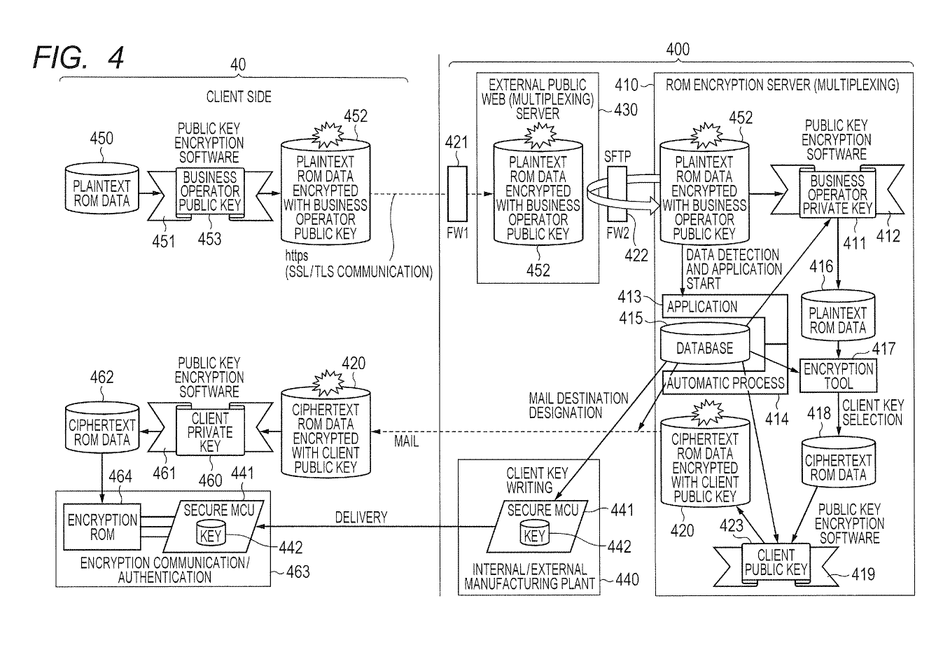

A system 400 according to the disclosure will be described with reference to FIG. 4. FIG. 4 is a diagram for showing an outline of a configuration of the system 400.

The system 400 includes a ROM encryption server 410, an external public webserver 430, and a manufacturing plant 440. The ROM encryption server 410, the external public webserver 430, and the manufacturing plant 440 are realized by computers each having the same configuration as the computer 300. The system 400 is operated by the service provider. The system 400 can be communicated with a server 40.

The external public webserver 430 includes plaintext ROM data 452 encrypted with a business operator public key. In a situation, the external public webserver 430 is realized by a computer having the same configuration as the computer 300.

In the following description, the “business operator public key” is a key that is prepared by a business operator providing the encryption services according to the embodiment and is released by the business operator on the assumption that the key is used in a public key encryption method.

The external public webserver 430 can be communicated with the server 40 through a firewall 421. Further, the external public webserver 430 can be communicated with the ROM encryption server 410 through a firewall 422.

### (Client)

The server 40 includes plaintext ROM data 450, a business operator public key 453, and public key encryption software 451. When the plaintext ROM data 450 is encrypted using the business operator public key 453 and the public key encryption software 451, the server 40 generates plaintext ROM data 452 encrypted with the business operator public key 453. Further, the server 40 includes ciphertext ROM data 420, public key encryption software 461, ciphertext ROM data 462, and an encryption communication/authentication module 463. The server 40 is operated by the client. The encryption communication/authentication module 463 includes a secure MCU 441 and an encryption ROM 464. A key 442 is written into the secure MCU 441. As will be described later, the secure MCU 441 is provided by the service provider that operates the system 400.

The user (client) of the server 40 encrypts the plaintext ROM data 450 using the business operator public key 453 to generate the plaintext ROM data 452. The server 40 transmits the plaintext ROM data 452 to the system 400 on the basis of an instruction of the client. The server 40 transmits the plaintext ROM data 452 using, for example, SSL/TLS (Secure Socket Layer/Transport Layer Security) communications. However, the present invention is not limited to this. At least, a mechanism that can perform encrypted communications can be used.

### (Service Provider)

The ROM encryption server 410 is realized by, for example, a computer having the same configuration as the computer 300. The ROM encryption server 410 includes the plaintext ROM data 452, public key encryption software 412, a business operator private key 411, an application 413, an automatic process 414, a database 415, plaintext ROM data 416, an encryption tool 417, ciphertext ROM data 418, a client public key 423, and the ciphertext ROM data 420.

In the following description, the “business operator private key” is a key that is prepared by a business operator providing the encryption services according to the embodiment and is kept secret by the business operator on the assumption that the key is used in a public key encryption method. Further, the “client public key” is a key that is prepared by a user of the encryption services according to the embodiment and is released by the user on the assumption that the key is used in a public key encryption method.

The external public webserver 430 receives the plaintext ROM data 452 transmitted from the server 40 through the firewall 421.

The plaintext ROM data 452 is encrypted with the business operator public key 453. The business operator private key 411 is used for the public key encryption software 412, and decrypts the plaintext ROM data 452 to generate the plaintext ROM data 416.

When the application 413 detects that the plaintext ROM data 452 has been sent to the ROM encryption server 410 from the server 40, a preliminarily-set process is realized. The realized process is, for example, an encryption process using the business operator private key 411 and the public key encryption software.

The automatic process 414 can include a process realized on the basis of a program preliminarily loaded in the ROM encryption server 410.

The database 415 holds keys assigned to the respective clients for encryption and decryption. The database 415 is realized in, for example, the hard disk 5 of the computer 300.

The encryption tool 417 encrypts the plaintext ROM data 416 using the public key held in the database 415 to generate the ciphertext ROM data 418. The CPU 1 executes the public key encryption software 419, and encrypts the ciphertext ROM data 418 using the client public key 423 to generate the ciphertext ROM data 420.

The ROM encryption server 410 transmits the ciphertext ROM data 420 to the server 40 using the preliminarily-designated destination of the mail.

The manufacturing plant 440 includes the key 442. The key 442 includes the secure MCU 441. The CPU 1 of the ROM encryption server 410 reads the key held in the database 415, and writes the same into the manufacturing plant 440 as the key 442. The secure MCU 441 having the key 442 written is delivered to the server 40 by the service provider.

The client generates the encryption communication/authentication module 463 obtained by integrating the encryption ROM 464 and the secure MCU 441 in the server 40.

### [Characteristic of the System]

According to the system of the disclosure, the ROM encryption server 410 is located in the firewall 422 to handle secure information, and cannot be accessed from the outside of the firewall 422. The ROM encryption server 410 accesses the external public webserver 430 at preliminarily-set time intervals to obtain data (for example, the plaintext ROM data 452) stored in the external public webserver 430. The key used for the encryption tool is managed by the database 415, and is used on a client basis.

Since the communication route from the client to the service provider is encrypted, the communications using the communication route are protected from wiretapping or falsification by a third party. Further, the communication route from the service provider to the client can be doubly protected by, for example, PGP and https. Therefore, according to the communications using such a communication route, a leakage of data can be prevented even in the case where a security hole is found in PGP.

### [Control Structure]

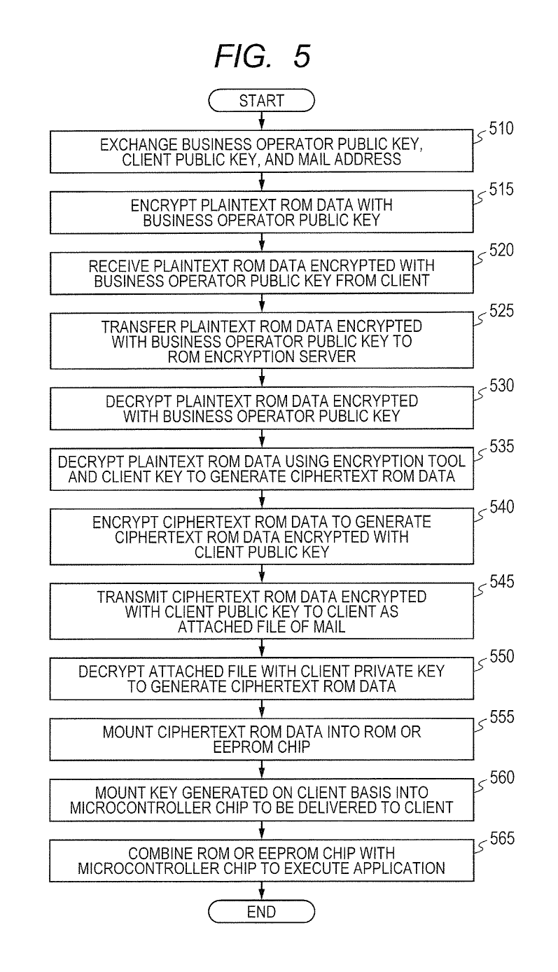

A control structure of a system according a situation will be described with reference to FIG. 5. FIG. 5 is a flowchart for showing a part of a process performed between the service provider and the client.

In Step 510, the service provider and the client exchange the public keys generated by the public key encryption software and mail addresses used for data communications. Each of the exchanged public keys and mail addresses is stored into the server 40 used by the client and the server (for example, the ROM encryption server 410) used by the service provider. More specifically, the business operator public key 453 and the business operator mail address are stored into the server 40 used by the client, and the client public key 423 and the client mail address are stored into the server (for example, the ROM encryption server 410) used by the service provider.

In Step 515, the client allows the public key encryption software using the business operator public key 453 of the service provider to execute an encryption process for the plaintext ROM data 450 into which the plaintext content created by the client is stored. In the encryption process, the plaintext ROM data 452 encrypted with the business operator public key 453 is generated, and is held by the server used by the client.

In Step 520, the service provider receives the plaintext ROM data 452 encrypted with the business operator public key 453 from the server 40 of the client in, for example, the external public webserver 430. More specifically, the server 40 uses a web browser screen of the external public webserver 430 to which the SSL/TLS communications (URL starts with https) provided by the service provider are applied, and transfers the plaintext ROM data 452 to the external public webserver 430.

In Step 525, the ROM encryption server 410 operated by the service provider periodically accesses the external public webserver 430 through the firewall 422 to confirm the presence or absence of the plaintext ROM data 452. When the ROM encryption server 410 accesses the external public webserver 430 after the plaintext ROM data 452 is stored into the external public webserver 430, the ROM encryption server 410 detects the presence of the plaintext ROM data 452. When the ROM encryption server 410 confirms the presence of the plaintext ROM data 452 in the external public webserver 430, the ROM encryption server 410 reads the plaintext ROM data 452 to hold the same in an internal memory device. Thereafter, the plaintext ROM data 452 on the external public webserver 430 is deleted.

In Step 530, the ROM encryption server 410 decrypts the “plaintext ROM data 452” read from the external public webserver 430 using the business operator private key 411 prepared by the service provider and the public key encryption software 412, and generates the plaintext ROM data 416.

In Step 535, the ROM encryption server 410 encrypts the plaintext ROM data 416 using the key prepared for the client by the service provider and the encryption tool 417. In the encryption process, the ciphertext ROM data 418 is generated.

In Step 540, the ROM encryption server 410 encrypts the ciphertext ROM data 418 using the client public key 423 and the public key encryption software. In the encryption process, the ciphertext ROM data 420 encrypted with the client public key 423 is generated.

In Step 545, the ROM encryption server 410 creates a mail to be sent to the preliminarily-designated client mail address. The ROM encryption server 410 transmits the ciphertext ROM data 420 created in Step 540 to the server 40 of the client as an attached file of the mail.

In Step 550, when receiving the mail transmitted from the ROM encryption server 410, the server 40 of the client extracts the attached file. The server 40 decrypts the attached file using the client private key 460 and the public key encryption software 461. In the decryption process, the ciphertext ROM data 462 is generated.

In the following description, the “client private key” is a key that is prepared by a user of the encryption services according to the embodiment and is kept secret by the user on the assumption that the key is used in a public key encryption method.

In Step 555, the server 40 of the client mounts the content of the ciphertext ROM data 462 into a ROM or an EEPROM chip to produce the encryption ROM 464.

In Step 560, the service provider mounts the key 442 generated on a client basis into a microcontroller chip to produce the secure MCU 441, and delivers the secure MCU 441 to the client. It should be noted that the process of Step 560 may be executed before Steps 545, 550, and 555 in a different situation.

In Step 565, the server 40 of the client combines the encryption ROM 464 created in Step 555 with the secure MCU 441 delivered from the manufacturing plant 440 in Step 560, so that a target application can be operated without allowing a third party to know the content created by the client and mounted in the encryption ROM 464.

### <For a Plurality of Clients>

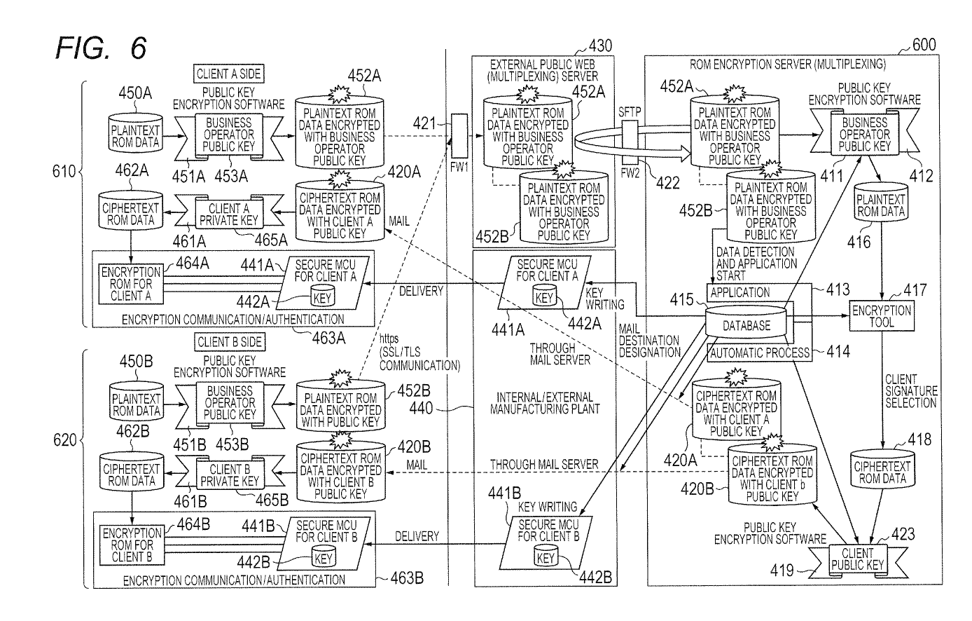

A system according to a different situation will be described with reference to FIG. 6. FIG. 6 is a diagram for showing a configuration in the case where services are provided to a plurality of clients.

A first client A uses a server 610. The server 610 includes plaintext ROM data 450A, a business operator public key 453A, public key encryption software 451A, plaintext ROM data 452A, ciphertext ROM data 420A, a client A private key 465A, public key encryption software 461A, ciphertext ROM data 462A, and an encryption communication/authentication module 463A. The encryption communication/authentication module 463A includes an encryption ROM 464A and a secure MCU 441A.

A second client B uses a server 620. The server 620 includes plaintext ROM data 450B, a business operator public key 453B, public key encryption software 451B, plaintext ROM data 452B, ciphertext ROM data 420B, a client B private key 465B, public key encryption software 461B, ciphertext ROM data 462B, and an encryption communication/authentication module 463B. The encryption communication/authentication module 463B includes an encryption ROM 464B and a secure MCU 441B.

The server 610 and the server 620 can be communicated with the external public webserver 430 through the firewall 421. The external public webserver 430 can hold the plaintext ROM data 452A and 452B. The plaintext ROM data 452A is transmitted by the server 610. The plaintext ROM data 452B is transmitted by the server 620.

The external public webserver 430 is electrically coupled to a ROM encryption server 600 through the firewall 422. The ROM encryption server 600 includes the plaintext ROM data 452A and 452B, the business operator private key 411, the application 413, the automatic process 414, the database 415, the plaintext ROM data 416, the encryption tool 417, the ciphertext ROM data 418, the client public key 423, and the ciphertext ROM data 420A and 420B.

The ROM encryption server 600 is electrically coupled to a computer of the manufacturing plant 440. The manufacturing plant 440 includes the secure MCU 441A and the secure MCU 441B. The secure MCU 441A includes a key 442A. The secure MCU 441B includes a key 442B. The key 442A is delivered to the client A. The client A produces the encryption communication/authentication module 463A using the secure MCU 441A and the encryption ROM 464A. The key 442B is delivered to the client B. The client B produces the encryption communication/authentication module 463B using the secure MCU 441B and the encryption ROM 464B.

### [Characteristic of the System]

As similar to the system shown in FIG. 5, the system shown in FIG. 6 is configured in such a manner that the ROM encryption server 600 is located in the firewall 422 to handle secure information, and cannot be accessed from the outside of the firewall 422. The ROM encryption server 600 accesses the external public webserver 430 at preliminarily-set time intervals to obtain data (for example, the plaintext ROM data 452A and 452B) stored in the external public webserver 430. The key used for the encryption tool is managed by the database 415, and is used on a client basis.

Since the communication routes from the clients to the service provider are encrypted, the communications using the communication routes are protected from wiretapping or falsification by a third party. Further, the communication routes from the service provider to the clients can be doubly protected by, for example, PGP and https. Therefore, according to the communications using such communication routes, a leakage of data can be prevented even in the case where a security hole is found in PGP. It should be noted that the number of clients is not limited to the number that can be read from FIG. 6. The services according to the disclosure can be provided to more clients.

### <Effect of Embodiment>

As described above, according to the embodiment, the encryption keys and the encryption programs are managed and operated in an area where security is secured by the service provider. Therefore, risks of loss, leakage, and falsification of the encryption keys and the encryption programs that are security assets can be considerably reduced. The lines used to transfer content to/from the client are protected by encryption, and thus can be protected from threats of wiretapping and falsification by a third party against the communication routes.

The key used in the “encryption tool” is prepared for each client. Thus, even if a leakage of the key or other accidents occur, a range of the damage can be localized.

Since the process is automated, the number of work steps of the client can be reduced and the process TAT can shortened. As a result, the frequency of operation errors can be reduced.

### Second Embodiment

Hereinafter, a second embodiment will be described. An outline of a configuration according to the second embodiment is as follows.

(1) A client prepares a PC coupled to the Internet. A web browser, mail software, public key encryption software, and a public key and a private key generated by the software are installed in the PC.

(2) A service provider prepares a ROM encryption server that receives content sent from the client as an e-mail to perform an encryption process, and the like, and an external public webserver that returns the encrypted content to the client.

(3) In the external public webserver, mounted is an environment in which the external public webserver is coupled to the ROM encryption server through the Internet and an intranet. A Firewall is provided in the network if necessary.

(4) In the ROM encryption server, mounted is an environment in which data transfer using an attached file of a mail, an encryption process and a decryption process by the public key encryption software, an encryption process by an encryption tool, client key and mail address management, and data transfer to the external public webserver can be executed.

In the following description, the “client key” is a key that is prepared by a business operator providing the encryption services according to the embodiment or by a person who receives the services, and is kept secret on the assumption that the key is used in a common key encryption method.

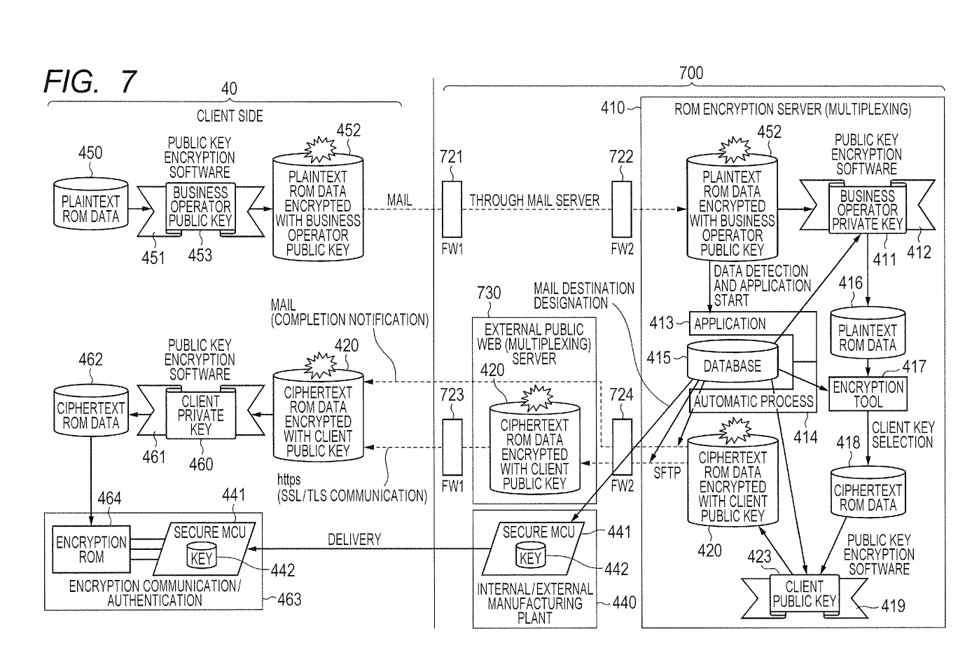

A system according to a different situation will be described with reference to FIG. 7. FIG. 7 is a block diagram for showing a configuration of a system 700 according to the second embodiment.

In the different situation, a ROM encryption server 410 is located in a firewall 722 to handle secure information, and cannot be accessed from the outside of the firewall 722. The ROM encryption server 410 writes data into an external public webserver 730 at preliminarily-set regular time intervals. The IP (Internet Protocol) address of the client is defined in advance in the firewall 721, and it is possible to prevent a third party other than the client from accessing.

More specifically, the system 700 includes the ROM encryption server 410, an external public webserver 730, and a manufacturing plant 440. The external public webserver 730 is electrically coupled to the ROM encryption server 410 through a firewall 724. The external public webserver 730 can store ciphertext ROM data 420. The ciphertext ROM data 420 is transmitted from the ROM encryption server 410 to the external public webserver 730 on the basis of a mail destination designated by a database 415.

The external public webserver 730 transmits the ciphertext ROM data 420 to the client through a firewall 723. The ROM encryption server 410 transmits to the client completion notification indicating that the encryption process has been completed on the basis of the mail destination designated by the database 415. When receiving the ciphertext ROM data 420, the client decrypts the same using public key encryption software 461 to obtain ciphertext ROM data 462. Further, the client fixes the ciphertext ROM data 462 as an encryption ROM 464 using the encryption communication/authentication module 463, and combines the encryption ROM 464 with a secure MCU 441. Accordingly, a target application can be executed.

According to the system shown in FIG. 7, since the communication route from the client to the service provider can be encrypted by, for example, PGP, the communications using the communication route are protected from wiretapping or falsification by a third party. Further, the communication route from the service provider to the client is doubly protected by, for example, PGP and https. Therefore, according to the communications using the communication route, a leakage of data can be prevented even in the case where a security hole is found in PGP.

### [Control Structure]

Step (1): The client and the service provider exchange the public keys generated in advance by the public key encryption software and the mail addresses to be used.

Step (2): The client allows public key encryption software 451 to encrypt the “plaintext ROM data” having the created plaintext content stored with a business operator public key 453 of the service provider. When the encryption process is executed, the plaintext ROM data encrypted with the business operator public key is generated.

Step (3): The client transmits the plaintext ROM data encrypted with the business operator public key to the service provider as an attached file of a mail.

Step (4): When the presence of the “plaintext ROM data encrypted with the business operator public key” transferred to the ROM encryption server is confirmed in the ROM encryption server, the “plaintext ROM data encrypted with the business operator public key” is decrypted with the business operator private key of the service provider. When the decryption process is executed, the “plaintext ROM data” is generated.

Step (5): The ROM encryption server encrypts the “plaintext ROM data” generated in Step (4) using the “encryption tool” with the key prepared for the client. When the process is executed, the “ciphertext ROM data” is generated.

Step (6): The ROM encryption server encrypts the “ciphertext ROM data” with the client public key using the public key encryption software. The “ciphertext ROM data encrypted with the client public key” is generated.

Step (7): The encryption server transfers the “ciphertext ROM data encrypted with the client public key” generated in Step (6) to the external public webserver.

Step (8): When Step (7) is completed, the ROM encryption server 410 deletes the “plaintext ROM data encrypted with the client public key”, the “plaintext ROM data”, and the “ciphertext ROM data” stored therein. The ROM encryption server 410 transmits a mail notifying the completion of the encryption process to the client.

Step (9): When the client receives the mail of Step (8), the client transfers the ciphertext ROM data 420 transferred to the external public webserver 730 to the server 40 of the client. The server 40 of the client receives the ciphertext ROM data 420 encrypted with the client public key.

Step (10): The client decrypts the received ciphertext ROM data 420 with the client private key 460. The ciphertext ROM data 462 is generated in the decryption process.

Step (11): The client mounts the content of the ciphertext ROM data 462 into a ROM or an EEPROM chip.

Step (12): The service provider produces the secure MCU 441 by mounting the key 442 generated on a client basis into the microcontroller chip 441 in the manufacturing plant 440, and delivers the secure MCU 441 to the client.

Step (13): The client combines the ROM or the EEPROM chip created in Step (11) with the secure MCU 441 delivered in Step (12). Accordingly, a target application can be operated without allowing a third party to know the content mounted in the ROM or the EEPROM chip and created by the client.

### <Effect of Embodiment>

The data transfer from the client to the service provider is realized as an attached file of a mail. Accordingly, if a mail can be used even in an environment where a web browser for transferring data to the service provider cannot be used, the process same as that in the first embodiment can be realized.

Further, as a data transfer unit from the service provider to the client, a web browser is used instead of a mail. Accordingly, if a web browser can be used even in an environment where a mail cannot be used when transferring data to the client, the process same as that in the first embodiment can be executed.

### Third Embodiment

Hereinafter, a third embodiment will be described. An outline of the technical concept according to the third embodiment is as follows.

(1) A client prepares a PC coupled to the Internet. Mail software, public key encryption software, and a public key and a private key generated by the software are installed in the PC.

(2) A service provider prepares a ROM encryption server mounting respective functions to perform mail communications with the client, an encryption process and a decryption process by the public key encryption software, and encryption using an encryption tool. A firewall can be provided in a network if necessary.

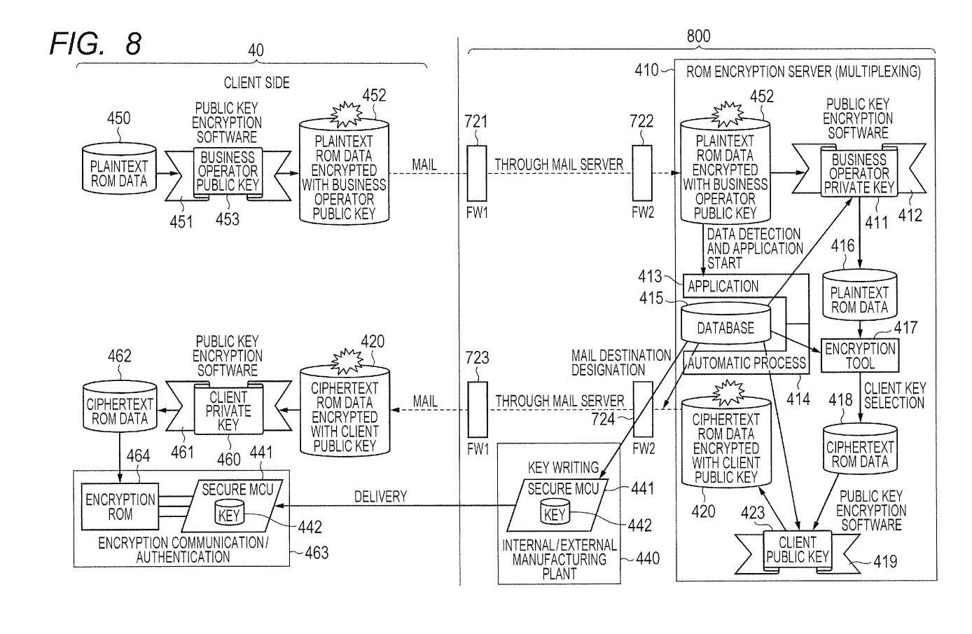

A system according to a different situation will be described with reference to FIG. 8. FIG. 8 is a diagram for showing an outline of a configuration of the system 800 according to the different situation. The system 800 includes a ROM encryption server 410 and a manufacturing plant 440. The system 800 shown in FIG. 8 is different from the system 700 shown in FIG. 7 in that the external public webserver 730 is not provided.

### [Control Structure]

Step (1): The client and the service provider mutually exchange the public keys generated in advance by the public key encryption software and the mail addresses to be used.

Step (2): The client encrypts plaintext content created as plaintext ROM data 450 using a business operator public key 453 of the service provider and the public key encryption software. When the process is executed, plaintext ROM data 452 encrypted with the business operator public key 453 is generated.

Step (3): A server 40 of the client transmits the plaintext ROM data 452 encrypted with the business operator public key 453 to the service provider as an attached file of a mail. The plaintext ROM data 452 is transmitted to the ROM encryption server 410 through a mail server.

Step (4): The ROM encryption server 410 decrypts the plaintext ROM data 452 using a business operator private key 411 and the public key encryption software. Plaintext ROM data 416 is generated in the decryption process.

Step (5): The ROM encryption server 410 encrypts the plaintext ROM data 416 using the key prepared for the client and the “encryption tool”. Ciphertext ROM data 418 is generated in the encryption process.

Step (6): The ROM encryption server 410 encrypts the ciphertext ROM data 418 using a client public key 423 and the public key encryption software. Ciphertext ROM data 420 encrypted with the client public key is generated in the encryption process.

Step (7): The ROM encryption server 410 transmits the ciphertext ROM data 420 generated in Step (6) to the address of the client as an attached file of an e-mail.

Step (8): When receiving the e-mail from the ROM encryption server 410, the server 40 of the client decrypts the attached file using a client private key 460 and the public key encryption software. Ciphertext ROM data 462 is generated in the decryption process.

Step (9): The client mounts the content of the ciphertext ROM data 462 into a ROM or an EEPROM chip.

Step (10): On the other hand, the service provider produces a secure MCU 441 by mounting the key 442 generated on a client basis into a microcontroller chip, and delivers the secure MCU 441 to the client.

Step (11): The client combines the ROM or the EEPROM chip created in Step (9) with the secure MCU 441 delivered in Step (10). Accordingly, a target application can be operated without allowing a third party to know the content mounted in the ROM or the EEPROM chip and created by the client.

### <Effect of Embodiment>

In a situation, the ROM encryption server 410 transmits the ciphertext ROM data 420 to the client as an attached file of an e-mail. Therefore, secure information can be provided to the client even under a communication environment where only an e-mail function can be used.

An attached file method of an e-mail is used as a unit for transmitting and receiving a file between the client and the service provider. Therefore, even in an environment where only a function of transmitting and receiving an e-mail can be used, the process same as that in the first embodiment can be realized.

### Fourth Embodiment

Hereinafter, a fourth embodiment will be described. The technical concept according to the fourth embodiment is as follows.

(1) A client prepares a PC coupled to the Internet. Web browser software, public key encryption software, and a public key and a private key generated by the software are installed in the PC.

(2) A service provider prepares an external public webserver realized in the SSL/TLS environment to communicate data with the client, and a ROM encryption server coupled to the external public webserver through a network. A firewall is coupled in an intranet if necessary.

(3) In the external public webserver, mounted is an environment in which the external public webserver is coupled to the ROM encryption server through the Internet or the intranet.

(4) In the ROM encryption server, mounted is an environment in which data transfer to/from the external public webserver, an encryption process and a decryption process by the public key encryption software, and an encryption process by an encryption tool can be executed.

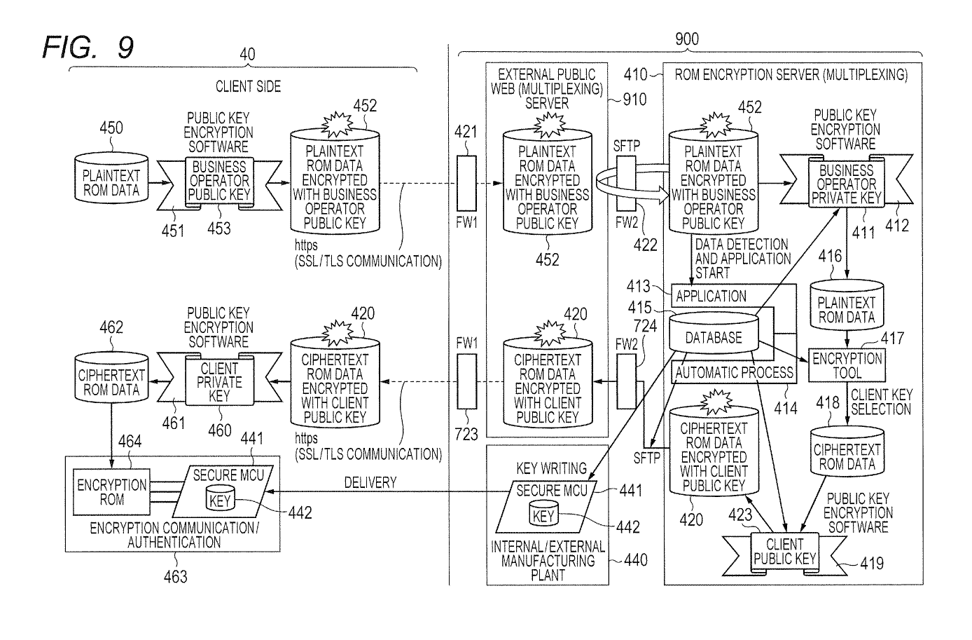

A system according to the fourth embodiment will be described with reference to FIG. 9. FIG. 9 is a diagram for showing a configuration of a system 900 according to the fourth embodiment.

The system 900 according to the embodiment is different from those according to the above-described embodiments in that a file is transmitted and received between the client and the service provider by a web browser method. Accordingly, the process same as that in the first embodiment can be realized even in an environment where a file cannot be transmitted and received using an e-mail due to the limited capacity of an attached file of the e-mail or an environment where only a web browser function can be used.

The system 900 includes a ROM encryption server 410, an external public webserver 910, and a manufacturing plant 440. The external public webserver 910 can include plaintext ROM data 452 and ciphertext ROM data 420. The external public webserver 910 holds the plaintext ROM data 452 received from a server 40 through a firewall 421.

The ROM encryption server 410 accesses the external public webserver 910 at preliminarily-set regular time intervals to confirm the presence or absence of the plaintext ROM data 452. When detecting the presence of the plaintext ROM data 452, the ROM encryption server 410 reads the plaintext ROM data 452 to be stored into a memory device inside the ROM encryption server 410. The plaintext ROM data 452 held in the external public webserver 910 is deleted.

When the ciphertext ROM data 420 is generated, the ROM encryption server 410 accesses the external public webserver 910 through a firewall 724 to write the ciphertext ROM data 420 into the external public webserver 910. The external public webserver 910 accepts access from the server 40 through a firewall 723. The server 40 reads the ciphertext ROM data 420 using an SSL/TLS communication system. Thereafter, the process same as the above is executed.

According to the embodiment, the ROM encryption server is located in a firewall 422 to handle secure information, and cannot be accessed from the outside of the firewall 422. The ROM encryption server 410 extracts data from the external public webserver 910 at regular intervals. The IP address of the client is defined in advance in the firewall 421. Therefore, it is possible to prevent a third party other than the client from accessing.

### [Control Structure]

Step (1): The client and the service provider mutually exchange the public keys generated in advance by the public key encryption software.

Step (2): The client encrypts plaintext ROM data 450 having the created plaintext content stored using a business operator public key 453 of the service provider and the public key encryption software. The plaintext ROM data 452 encrypted with the business operator public key is generated in the encryption process.

Step (3): The server 40 of the client transmits the plaintext ROM data 452 generated in Step (2) to the service provider using a web browser screen of the external public webserver to which the SSL/TLS communications (https) provided by the service provider are applied.

Step (4): When receiving the plaintext ROM data 452 from the server 40, the external public webserver 910 holds the plaintext ROM data 452 until preliminarily-defined conditions are established. The ROM encryption server 410 regularly accesses the external public webserver 910 to confirm the presence thereof. When the ROM encryption server 410 confirms the presence of the plaintext ROM data 452 in the external public webserver 910, the data is transferred from the external public webserver 910 to the ROM encryption server 410, and the plaintext ROM data 452 on the external public webserver 910 is deleted.

Step (5): The ROM encryption server 410 decrypts the plaintext ROM data 452 using a business operator private key 411 of the service provider and the public key encryption software. Plaintext ROM data 416 is generated in the decryption process.

Step (6): The ROM encryption server 410 encrypts the plaintext ROM data 416 using the key prepared for the client and an encryption tool 417. Ciphertext ROM data 418 is generated in the encryption process.

Step (7): The ROM encryption server 410 encrypts the ciphertext ROM data 418 using a client public key 423 and public key encryption software 419. The ciphertext ROM data 420 encrypted with the client public key is generated in the encryption process.

Step (8): The ROM encryption server 410 transfers the ciphertext ROM data 420 generated in Step (7) to the external public webserver 910. After confirmation of the transfer, the ROM encryption server 410 deletes the plaintext ROM data 452 encrypted with the business operator public key, the plaintext ROM data 416, and the ciphertext ROM data 420 encrypted with the client public key.

Step (9): The client transfers the ciphertext ROM data 420 generated in Step (8) to the server 40 of the client using a web browser screen of the external public webserver to which the SSL/TLS communications (https) provided by the service provider are applied.

Step (10): The client decrypts the received ciphertext ROM data 420 using a client private key 460 and the public key encryption software. Ciphertext ROM data 462 is generated in the decryption process.

Step (11): The client mounts the content of the ciphertext ROM data 462 into a ROM or an EEPROM chip.

Step (12): On the other hand, the service provider produces a secure MCU 441 by mounting a key 442 generated on a client basis into a microcontroller chip manufactured by the service provider, and delivers the secure MCU 441 to the client.

Step (13): The client combines the ROM or the EEPROM chip created in Step (11) with the secure MCU 441 delivered in Step (12). Accordingly, a target application can be operated without allowing a third party to know the content mounted in the ROM or the EEPROM chip and created by the client.

### <Effect of Embodiment>

According to the embodiment, the communication route from the client to the service provider is encrypted by https. Accordingly, even in the case where a security hole is found in PGP, a leakage of data can be prevented. Further, the communication route from the service provider to the client is also encrypted by https, and data itself is encrypted by a secure tool. Therefore, even in the case where a security hole is found in PGP, a leakage of data can be prevented.

The transmission and reception of a file between the client and the service provider are realized using a web browser. Therefore, even in the case where an e-mail cannot be used due to the limited size of an attached file of the e-mail or only a web browser function can be used, the process same as that in the first embodiment can be executed.

### Fifth Embodiment

Hereinafter, a fifth embodiment will be described. An outline of the technical concept according to the fifth embodiment is as follows.

(1) A client prepares a PC coupled to the Internet. Web browser software, mail software, public key encryption software, and a public key and a private key generated by the software are installed in the PC.

(2) A service provider prepares an external public webserver for receiving data sent from the client in the SSL/TLS communication environment, and a ROM encryption server coupled to the external public webserver through a network. A firewall may be provided in a network if necessary.

(3) In the external public webserver, mounted is an environment in which the external public webserver is coupled to the ROM encryption server through the Internet and an intranet.

(4) The ROM encryption server mounts an environment in which data transfer from the external public webserver, an encryption process and a decryption process by the public key encryption software, an electronic signature adding process by an electronic signature adding tool, client key management and mail address management of e-mails, and transmission of an e-mail can be executed.

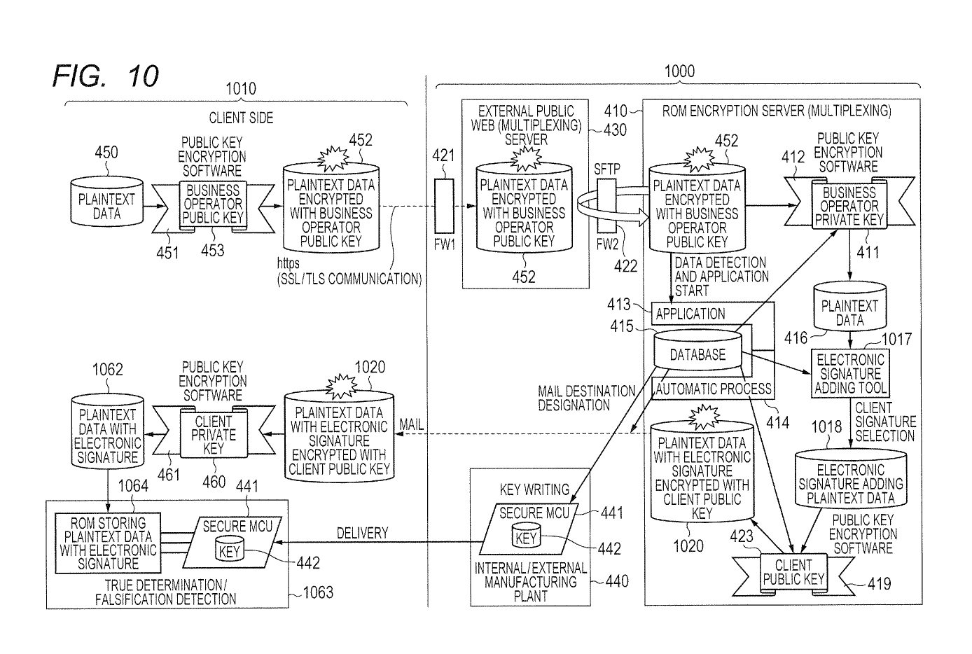

The fifth embodiment will be described with reference to FIG. 10. FIG. 10 is a diagram for showing an outline of a configuration of a system according to the fifth embodiment. The client uses a server 1010. The server 1010 includes plaintext ROM data 450, a business operator public key 453, plaintext ROM data 452, plaintext data with electronic signature 1020, a client private key 460, plaintext data with electronic signature 1062, and a true determination/falsification detection module 1063. The true determination/falsification detection module 1063 includes a ROM 1064 and a secure MCU 441. The secure MCU 441 includes a key 442.

A system 1000 includes a ROM encryption server 410, an external public webserver 430, and a manufacturing plant 440.

The ROM encryption server 410 generates plaintext data with electronic signature 1018 from plaintext ROM data 416 using an electronic signature adding tool 1017. The ROM encryption server 410 encrypts the plaintext data with electronic signature 1018 using a client public key 423 to generate the plaintext data with electronic signature 1020. The ROM encryption server 410 transmits the plaintext data with electronic signature 1020 to the server 1010 as an attached file of an e-mail.

When receiving the e-mail, the server 1010 extracts the plaintext data with electronic signature 1020, and decrypts the plaintext data with electronic signature 1020 using the client private key 460 and public key encryption software 461 to extract the plaintext data with electronic signature 1062.

The server 1010 mounts the plaintext data with electronic signature 1062 into a recording medium to generate the ROM 1064 having the plaintext data with electronic signature stored.

### [Control Structure]

Step (1): The client encrypts plaintext data 450 having plaintext content stored using the business operator public key of the service provider and the public key encryption software. The plaintext ROM data 452 encrypted with the business operator public key is generated in the encryption process.

Step (2): A server 40 transmits the plaintext ROM data 452 to the service provider using a web browser screen of the external public webserver to which the SSL/TLS communications (https) provided by the service provider are applied.

Step (3): The ROM encryption server 410 regularly confirms the plaintext ROM data 452 transferred to the external public webserver. When the ROM encryption server 410 confirms the presence of the “plaintext ROM data encrypted with the business operator public key in the external public webserver, the data is transferred to the ROM encryption server 410, and the plaintext ROM data 452 encrypted with the business operator public key on the external public webserver 910 is deleted.

Step (4): The ROM encryption server 410 decrypts the transferred plaintext ROM data 452 using a business operator private key 411 of the service provider and the public key encryption software. The plaintext data 416 is generated in the decryption process.

Step (5): The ROM encryption server 410 allows the electronic signature adding tool 1017 to perform the electronic signature adding process for the plaintext data 416 using the preliminarily-prepared key and function. When the process is executed, the plaintext data with electronic signature 1018 is generated.

Step (6): The ROM encryption server 410 encrypts the plaintext data with electronic signature 1018 using the client public key 423 and the public key encryption software. The plaintext data with electronic signature 1020 encrypted with the public key is generated in the encryption process.

Step (7): The ROM encryption server 410 creates a mail to be sent to the preliminarily-designated client mail address. The ROM encryption server 410 transmits the plaintext data with electronic signature 1020 created in Step (7) to the client as an attached file of the mail.

Step (8): After receiving the mail transmitted in Step (8), the server 40 of the client decrypts the attached file using the client private key 460 and the public key encryption software. The plaintext data with electronic signature 1062 is generated in the decryption process.

Step (9): The server 40 of the client mounts the content of the plaintext data with electronic signature 1062 into a ROM or an EEPROM chip.

Step (10): On the other hand, the service provider produces the secure MCU 441 by mounting the key 442 generated on a client basis into a microcontroller chip manufactured by the service provider, and delivers the secure MCU 441 to the client.

Step (11): The client combines the ROM or the EEPROM chip created in Step (10) with the secure MCU 441 delivered in Step (11). Accordingly, a target application can be operated after confirming that the plaintext data with electronic signature 1062 mounted in the ROM or the EEPROM chip and created by the client is for a person who created the electronic signature and is not falsified.

### [Screen]

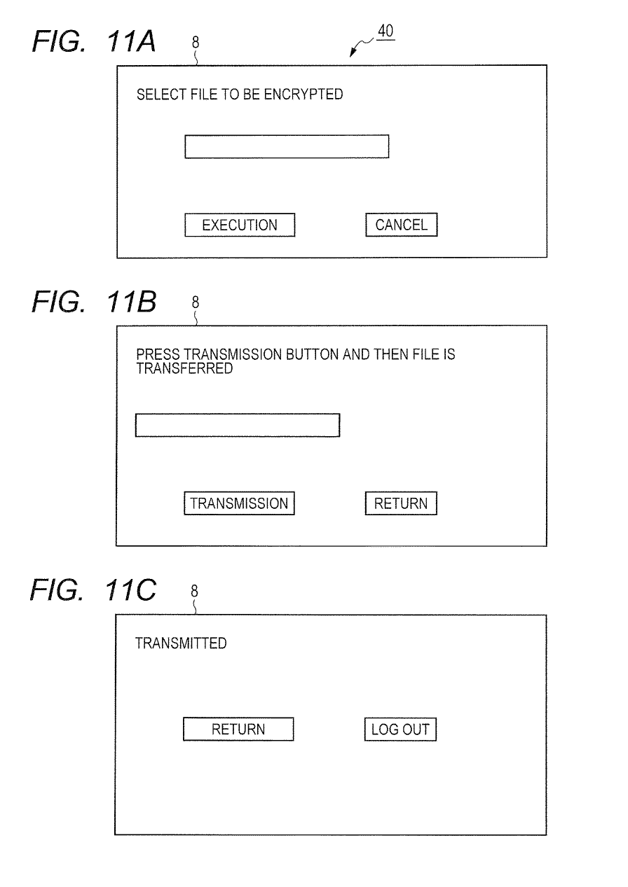

A display configuration of a screen used by the client will be described with reference to FIGS. 11A-C. FIGS. 11A-C are diagrams each showing an example of a screen displayed on a monitor 8 of a computer realizing the server 40.

As shown on a screen shown in FIG. 11A, the server 40 displays a screen for accepting selection of a file to be encrypted.

As shown on a screen shown in FIG. 11B, the server 40 displays a screen for accepting designation of the destination (service provider) of the data.

As shown on a screen shown in FIG. 11C, when receiving the ciphertext ROM data from the service provider, the server 40 displays a message notifying the reception and a message asking for whether or not to decrypt the data.

### SUMMARY

(1) As described above, the management and operation of the key of the “encryption tool” and the program itself are performed by the service provider. Therefore, a risk of loss, leakage, or falsification of the key of the “encryption tool” and the program itself for which the security is required can be considerably reduced.

(2) The lines used to transfer content between the client and the service provider is protected by the SSL/TLS communications. When the content is transmitted as an attached file of a mail, the encryption process by the “public key encryption software” is performed. Therefore, the data communications are protected from threats of wiretapping and falsification by a third party against the communication route.

(3) The key used in the “encryption tool” is prepared for each client. Thus, even if a leakage of the key or other incidents occur, the damage can be localized.

(4) Since the transmission and reception of the content data and the encryption process for the content are automated, the number of work steps required for the client and the process TAT (Turn Around Time) can be minimized. Further, the frequency of operation errors can be reduced as a result.

The invention achieved by the inventors has been described above in detail on the basis of the embodiments. However, it is obvious that the present invention is not limited to the above-described embodiments, but can be variously changed without departing from the scope of the invention.

1. A device for providing data security, the device comprising:
a memory; and
a processor that is configured to execute a command while being coupled to the memory,
the processor being configured to execute:
obtaining plaintext data that is transmitted from a client device and is encrypted with a public key;
obtaining the plaintext data by decrypting the encrypted plaintext data using a private key;
generating ciphertext data from the plaintext data using a preliminarily-prepared encryption tool;
encrypting the ciphertext data using a public key unique to a client;
transmitting the ciphertext data generated by the encryption to the client device; and
supplying a control module having the public key written to the client.

2. The device according to claim 1,
wherein the obtaining the plaintext data includes:
storing the plaintext data received from the client device into a memory area;
accessing the memory area at preliminarily-set timing; and
reading the plaintext data in the case where the plaintext data is stored in the memory area.

3. The device according to claim 1,
wherein the obtaining the plaintext data includes obtaining the plaintext data encrypted with each public key from each of a plurality of client devices, and
wherein the encrypting includes encrypting each ciphertext data using each public key unique to each client.

4. The device according to claim 1,
wherein the obtaining the plaintext data includes receiving the plaintext data through an e-mail or a browser.

5. The device according to claim 1,
wherein the transmitting to the client device includes transmitting to the client device through an e-mail or a browser.

6. A system for providing data security, the system comprising a server, the server comprising:
a unit of obtaining plaintext data that is transmitted from a client device and is encrypted with a public key;
a unit of obtaining the plaintext data by decrypting the encrypted plaintext data using a private key;
a unit of generating plaintext data with an electronic signature from the plaintext data using a preliminarily-prepared electronic signature adding tool;
a unit of encrypting the plaintext data using a public key unique to a client;
a unit of transmitting the plaintext data generated by the encryption to the client device; and
a unit of supplying to the client a control module combined with the plaintext data with an electronic signature and having the public key written.

7. The system according to claim 6,
wherein the unit of obtaining the plaintext data is configured to store the plaintext data received from the client device into a memory area, to access the memory area at preliminarily-set timing, and to read the plaintext data in the case where the plaintext data is stored in the memory area.

8. The system according to claim 6,
wherein the unit of obtaining the plaintext data is configured to obtain the plaintext data encrypted with each public key from each of a plurality of client devices, and
wherein the unit of encrypting the ciphertext data is configured to encrypt each ciphertext data using each public key unique to each client.

9. The system according to claim 6,
wherein the unit of obtaining the plaintext data is configured to receive the plaintext data through an e-mail or a browser.

10. The system according to claim 6,
wherein the unit of transmitting to the client device is configured to transmit to the client device through an e-mail or a browser.

11. An encryption method comprising:
obtaining plaintext data that is transmitted from a client device and is encrypted with a public key;
obtaining the plaintext data by decrypting the encrypted plaintext data using a private key;
generating ciphertext data from the plaintext data using a preliminarily-prepared encryption tool;
encrypting the ciphertext data using a public key unique to a client;
transmitting the ciphertext data generated by the encryption to the client device; and
supplying a control module having the public key written to the client.

12. The encryption method according to claim 11,
wherein the obtaining the plaintext data includes:
storing the plaintext data received from the client device into a memory area;
accessing the memory area at preliminarily-set timing; and
reading the plaintext data in the case where the plaintext data is stored in the memory area.

13. The encryption method according to claim 11,
wherein the obtaining the plaintext data includes obtaining the plaintext data encrypted with each public key from each of a plurality of client devices, and
wherein the encrypting the ciphertext data includes encrypting each ciphertext data using each public key unique to each client.

14. The encryption method according to claim 11,
wherein the obtaining the plaintext data includes receiving the plaintext data through an e-mail or a browser.

15. The encryption method according to claim 11,
wherein the transmitting to the client device includes transmitting to the client device through an e-mail or a browser.

16. A program allowing a computer to execute the method described in claim 11.
